(19) United States
(12) Patent Application Publication
(10) Pub. No.: US 2007/0053201 A1
(43) Pub. Date: Mar. 8, 2007

(54) Field display system

(76) Inventors: Paul H. Dietz, Hopkinton, MA (US); William S. Yerazunis, Acton, MA (US); Ramesh Raskar, Cambridge, MA (US)

Correspondence Address: Patent Department;Mitsubishi Electric Research Laboratories, Inc., 201 Broadway, Cambridge, MA, 02139, US

(21) Appl. No.: 11/209,366

(22) Filed: Aug. 23, 2005

(51) Int. Cl. F21V 5/00

(52) U.S. Cl. 362/559

(57) ABSTRACT

A display system includes display elements embedded in a playing surface. The display elements are configured to display images or video in the playing surface. The playing surface can be a soccer field, a football field, a rugby field, a baseball field, a track field, a horse racing track, a tennis court, a basketball court, a performance stage, and combinations thereof.

### FIELD OF THE INVENTION

This invention relates generally to display systems, and more particularly to display systems for sporting events.

### BACKGROUND OF THE INVENTION

Stadiums, arenas and other venues for sporting events have long featured scoreboards and other displays. These displays help spectators to keep track of the sporting event, as well as other related events. In the early days, number placards were put up by hand on sign boards. Over time, these systems have become more automated, first with mechanical systems and later with electronic systems. But, even in the early days, it was realized that because so many spectators are looking at the scoreboard, it is an excellent place for advertising and thus a source for revenue.

Over time, electronic scoreboards have evolved to include the ability to show images and videos. This enables more sophisticated advertising, and enhances the event experience for the spectator by showing player close-ups, instant replays, player information, graphical effects, etc. It is now the norm for major sporting venues to include sophisticated electronic signage.

A major limitation for electronic signs has been their physical size. Even though the signs have gotten much larger over the years, their ultimate size is limited by the amount of available space. The practical reality is that even large signs extend over only a small fraction of the field of view from most locations in the venue. Worse yet, the sign is removed from the game action, e.g., the field or floor, so spectators must look away from the action to view the display.

At the same time, television coverage of sporting events has also become more sophisticated. To aid viewer understanding and enjoyment, systems have been developed that allow commentators to annotate images of the playing field. As technology improved, more sophisticated annotations became feasible, such as adding ‘virtual’ first down lines in American football games and ball trajectories in tennis matches. Spectators have come to expect these sorts of enhancements of game coverage on television, but they are absent when attending a sporting event in person.

Clearly, it would be desirable to have a display system which overcame these limitations.

### SUMMARY OF THE INVENTION

A display system includes display elements embedded in a playing surface. The display elements are configured to display images or video in the playing surface. The playing surface can be a soccer field, a football field, a rugby field, a baseball field, a track field, a horse racing track, a tennis court, a basketball court, a performance stage, and combinations thereof.

### BRIEF DESCRIPTION OF THE DRAWINGS

FIG. 1A is a top view of a display system according to one embodiment of the invention;

FIG. 1B is a top view of a display system according to another embodiment of the invention;

FIG. 2 is a side view of a portion of the display system according to an embodiment of the invention;

FIG. 3 is a side view of a display element according to one embodiment of the invention; and

FIG. 4 is a side view of a display element according to another embodiment of the invention.

### DETAILED DESCRIPTION OF THE PREFERRED EMBODIMENT

### System Structure

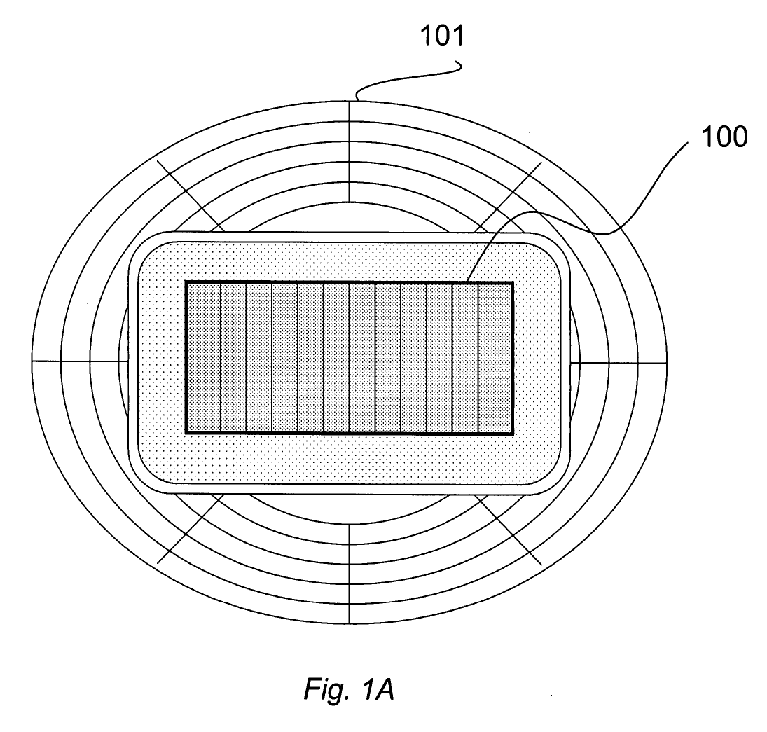

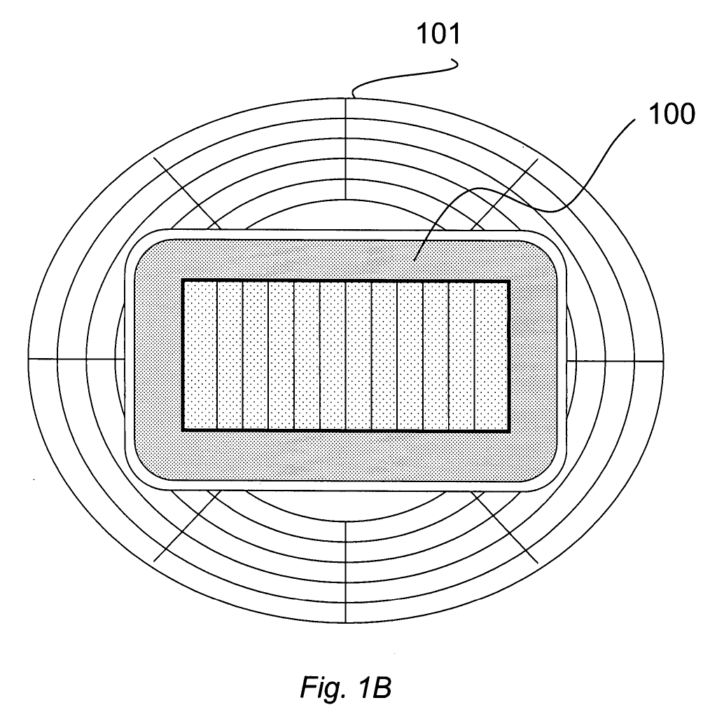

FIG. 1A shows an arrangement of a display system 100 according to one embodiment of the invention with respect to the stadium 101. The display system 100 is integrated with and extends over the playing surface 101. It should be noted that the display area can be limited to a portion of the playing surface. In contrast, FIG. 1B shows the display system 100 only in the ‘out-of-bounds’ area around the playing surface.

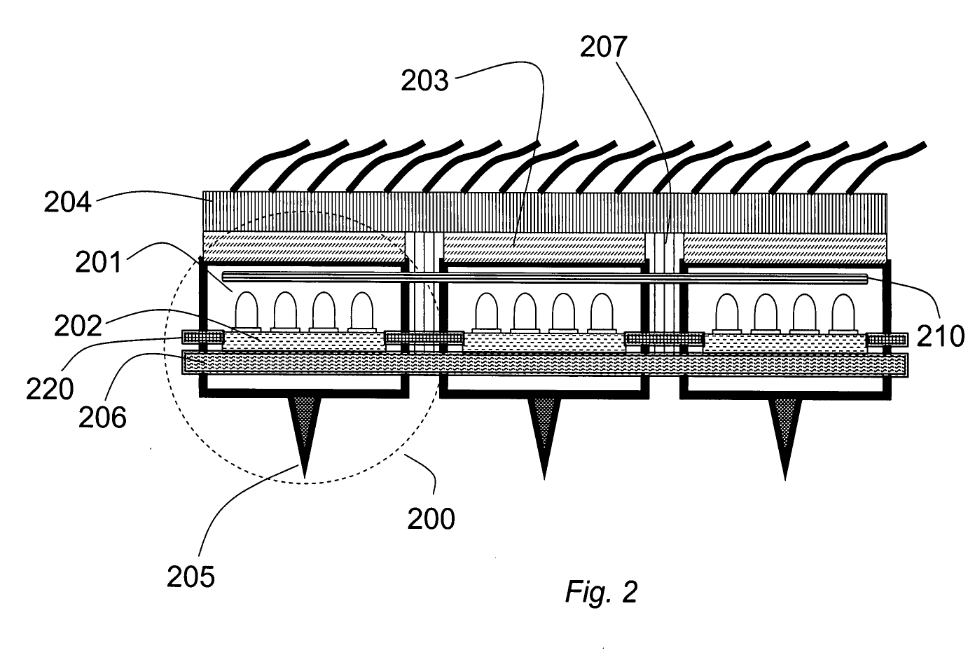

FIG. 2 shows a cut away side view of a portion of the display system. The display includes display elements 200 embedded in the playing surface. Each element includes an array of light emitters 201 arranged on a substrate, e.g., a circuit board 202. The circuit board provides mechanical and electrical connections for the light emitters. The light emitters can emit colored light, e.g., red, green, and blue (RGB) to provide a full range of colors. The light emitters can be incandescent light or solid state light emitters such as LEDs. Alternatively, the light emitters can be phosphorescent to provide a persistent image.

The display elements can be synchronized with stadium lights to improve contrast, direct attention and minimize power requirements

It should be noted that because of the very large scale the light emitters can be placed centimeters apart and still have a resolution comparable with conventional display systems.

Disposed above the light emitters 201, in a horizontal plane, is a transparent support plate 203. The support plate provides mechanical support for translucent artificial turf 204.

The entire structure is anchored into the ground by spikes 205, which also serve as heat sinks. For improved thermal management, a liquid cooling system 206 can be employed. Optional drainage channels 207 provide a path for water to flow off the field.

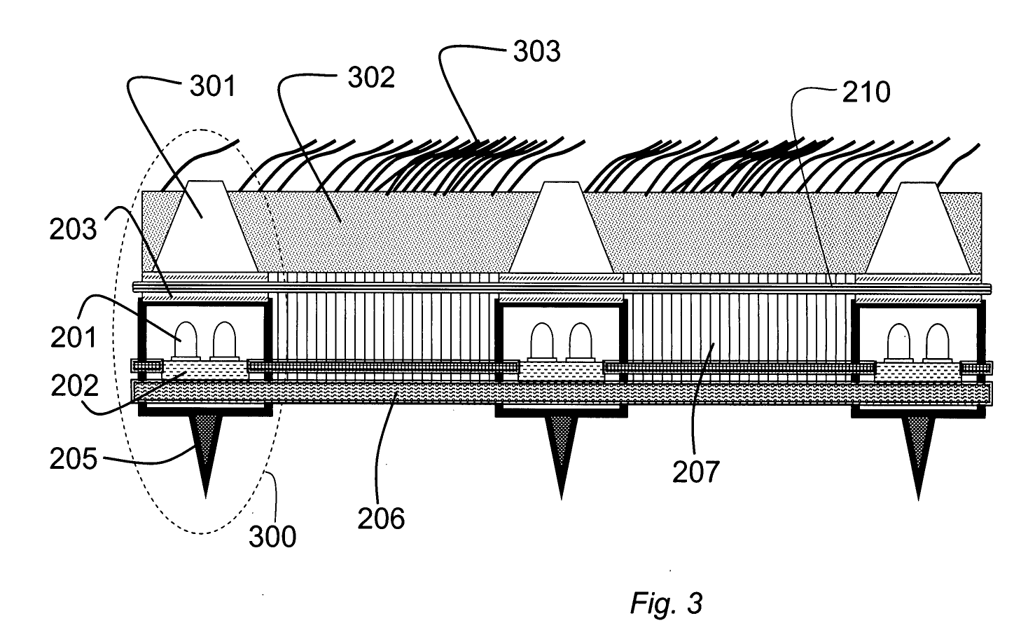

FIG. 3 shows a cut away side view of a display element 300 for an alternative embodiment of the invention. In this arrangement, grass is used instead of artificial turf. In this case, the transparent support is covered with a soil layer 302 in which grass 303 grows. Light pipes 301 conduct light from the emitters to the surface. These pipes protrude very slightly from the surface and are made of a translucent or transparent, flexible, but sturdy material selected to withstand physical stress.

To ease service requirements, the display elements 200 and 300 are arranged as interconnecting tiles. These tiles can be individually replaced.

For some applications, it would be useful to locate players and game equipment, e.g., balls. For this purpose, selected elements can include radio frequency identification (RFID) readers 210, or other types of sensors.

The elements are connected to a network 220 for power and communication.

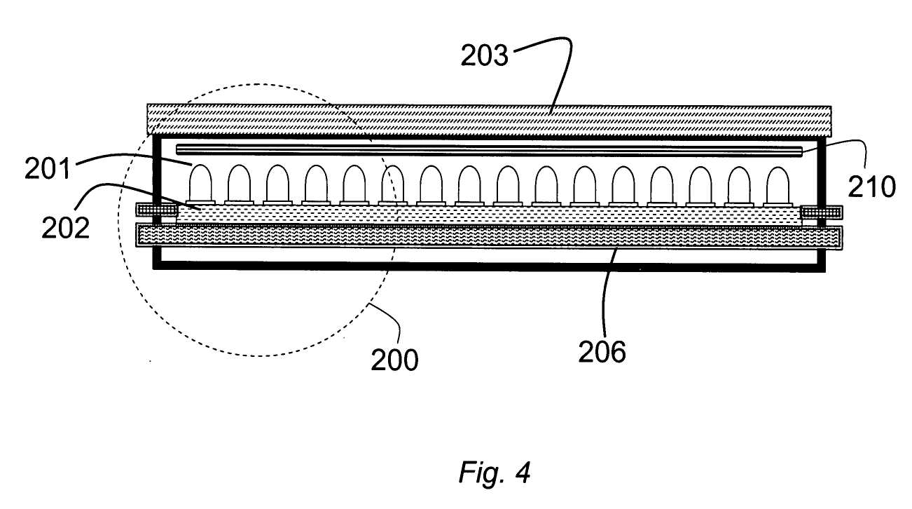

FIG. 4 shows a cut away side view of the invention for use on hard surfaces such as basketball courts, stages, and ice rinks. In this case there is no need for any sort of turf. For indoor applications, there is no need for drainage, so the drainage channels 207 have been removed, allowing the light emitters to be more closely spaced.

### System Operation

During operation of the system 100, current is supplied selectively to the light elements to render an image or a video. Because the display system is an integral part of the playing surface, images that are displayed can enhance the spectator's experience of the sporting events. For example, such annotations as the first down line for American football can now be shown directly on the playing surface. Team logos can be shown on the appropriate side. Scores, direction of play, player information, clocks, penalties, can also be shown on the field, either inside or outside the bounds of the official playing surface. Celebratory graphics can highlight key moments and, via player tracking, can move with the players.

The same sporting venue is often used for different sporting events such as soccer, football, baseball, lacrosse, rugby, track and field, etc. In addition, the same field can also be used for normal seasonal games, and special events such as ‘bowl’ games. In the prior art, the field would have to be remarked for each different event. That requires time, money, and material. With the display system as described the field marking can be changed instantly.

It should be noted that there are many possible variations in keeping with the spirit and scope of the invention. This would include use in other venues with different surfaces such as basketball courts, tennis courts, race tracks, performance stages, etc. Ice rinks are particularly well suited because ice is already quite transparent.

It should also be noted, that the field markings can be changed dynamically to enable a whole new genre of highly interactive games, such as maze games, or territorial games. It should also be noted a sequence of images can be displayed.

It should also be noted that the display elements can be adapted to ambient lighting conditions and motion of objects on the field.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A display system, comprising:
a plurality of display elements embedded in a horizontal playing surface, the plurality of display elements configured to display images in the playing surface.

2. The display system of claim 1, in which the playing surface is selected from the group consisting of a soccer field, a football field, a rugby field, a baseball field, a track field, a horse racing track, a tennis court, a basketball court, a performance stage, and combinations thereof.

3. The display system of claim 1, in which the plurality of display elements are embedded in a portion of a playing surface.

4. The display system of claim 1, in which the playing surface includes an out-of-bounds area.

5. The display system of claim 1, in which each display element further comprises:
an array of light emitters arranged on a substrate.

6. The display system of claim 5, in which the light emitters are of different colors.

7. The display system of claim 1, further comprising:
a transparent support plate disposed in a horizontal plane above the plurality of display elements; and
a translucent artificial turf arranged on the support plate.

8. The display system of claim 1, in which each display element includes a spike for anchoring the display element.

9. The display system of claim 8, in which each spike serves as a heat sink.

10. The display system of claim 1, in which each display element includes a light pipe for conducting light through a layer of soil and grass disposed in a horizontal plane above the plurality of display elements.

11. The display system of claim 1, in which selected display elements include radio frequency identification readers.

12. The display system of claim 1, in which the plurality of display elements are in a form of interlocking tiles.

13. The display system of claim 1, further comprising:
means for selectively supplying current to the display elements.

14. The display system of claim 1, in which the plurality of display elements indicate a field marking when activated.

15. The display system of claim 14, in which the indicating of the field marking is dynamic.

16. The display system of claim 1, in which the plurality of display elements render an arbitrary image.

17. The display system of claim 1, in which the plurality of display elements are phosphorescent to provide a persistent image.

18. The display system of claim 1, in which the plurality of display elements are synchronized to stadium lights.

19. A method for displaying an image, comprising:
embedding a plurality of display elements in a horizontal playing surface; and
selectively supplying power to the plurality of display elements to render images in the playing surface.

20. The method of claim 19, further comprising:
rendering a sequence of images as a video.

21. A display system, comprising:
a plurality of display elements configured to overlay images onto a horizontal playing surface.
